(19) United States
(12) Patent Application Publication
(10) Pub. No.: US 2004/0257348 A1
(43) Pub. Date: Dec. 23, 2004

(54) Multi-development picture and picture-frame structure

(75) Inventor: Chi-Yuan Ou, Taipei (TW)

Correspondence Address: BACON & THOMAS, PLLC, 625 SLATERS LANE, FOURTH FLOOR, ALEXANDRIA, VA, 22314

(73) Assignee: Smart Displayer Technology Co., Ltd., Taipei (TW)

(21) Appl. No.: 10/600,340

(22) Filed: Jun. 23, 2003

(51) Int. Cl. G09G 5/00

(52) U.S. Cl. 345/204

(57) ABSTRACT

A multi-development picture and picture-frame structure, mainly includes a picture-frame body, and a bistable display with its control circuit, wherein the control circuit is provided with a microprocessor, a memory with its driving circuit, and a memory card reader. The image data in the memory card are accessed by the card reader and stored in the memory such that the image can be displayed on a bistable display without continuous power supply. This is done by selecting the variant image and displaying time through the selection buttons, so as to constitute the displaying effect as a photo picture. The image data can also be received from variant storage through a USB interface, and/or an infrared transmission interface, and/or a Bluetooth transmission interface.

### 1. FIELD OF THE INVENTION

The invention relates to a multi-development picture and picture-frame structure, particularly to the one which can be used for displaying a digital image data without requiring continuous power supply after displaying, and resulting in the display of a picture effect.

### 2. DESCRIPTION OF THE PRIOR ART

Following the development of technology, the use of a digital camera has become very popular nowadays. The picture effect of a digital camera can be reviewed during or after taking a picture. However, developing a picture is more expensive, and the image quality of the developed picture is different from that inspected in a digital camera. Consequently, the percentage of developing a picture for a digital camera is only about 8%. It is thus short of economic benefits, and the images taken by a camera user are usually not displayed in the form of picture owing to the high development cost.

Although there is a Digital PICTURE FRAME for displaying a frame from the digital camera on the market, it is a kind of virtual product that is formed by downloading a decorative pattern from a network. Afterward, the virtual frame image is manipulated to fit the frame of the picture taken by the camera user. This kind of product is called “picture” or “PICTURE FRAME”.

There is another kind of “Digital PICTURE FRAME” that displays the digital frame on an LCD and is different from the aforementioned virtual product. However, due to the necessity of maintaining power supplying for using the LCD, this kind of PICTURE FRAME is not convenient to use, and therefore is hardly to be popularized.

### SUMMARY OF THE INVENTION

In light of the disadvantages of the prior arts, the invention provides a multi-development picture and picture frame structure that aims to ameliorate at least some of the disadvantages of the prior art or to provide a useful alternative.

It is the main object of the invention to provide a multi-development picture and PICTURE FRAME structure such that the image data of pictures taken by a digital camera can be displayed, and continuous power supply is not needed after displaying. This is to obtain the same effect as a photo picture and have an ornamental function such that the picture can be displayed or furnished or to be carried along.

The picture of the invention includes a control circuit having a bistable display, a microprocessor, a memory with its driving circuit, and a memory card reader. The image data in memory card of digital camera can be accessed by the card reader and stored in the memory. By selecting variant buttons, image data are decoded, decrypted, sorted and transformed into a displaying format. Thereafter, the image data are displayed on the bistable display without continuously supplying power after being displayed.

In one of the embodiments of the invention, the memory is provided with an image transformation program as well as an image staying and replacing program in order to transform the digital image data into the image displaying format. Consequently, the staying and replacing time of the image is controlled by the program.

In other embodiment of the invention, the control circuit also includes transmission interfaces of infrared, and/or Bluetooth, and/or USB for receiving image data from varied storage.

In another embodiment of the invention, the control circuit also includes transmission interfaces of Infrared and/or Bluetooth and/or USB for receiving image data from variant storage.

In still another embodiment of the invention, the frame structure includes a number of frame windows and selection buttons on its backside in order to view the variant images. The images disposed to be displayed will be set up for their sequence number and displaying time by the selection buttons, and then can be displayed, through the control circuit and according to their set sequence and time, one by one on the front display.

In still another embodiment of the invention, the working power supply can be connected from the external power source transformer through the power source outlet for providing the power source required by the whole control circuit and the bistable display.

The foregoing object and summary provide only a brief introduction to the invention. To fully appreciate these and other objects of the invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the invention will become manifest to those versed in the art upon making reference to the detailed description and the accompanying sheets of drawings in which a preferred structural embodiment incorporating the principles of the invention is shown by way of illustrative example.

### BRIEF DESCRIPTION OF THE DRAWINGS

FIG. 1 is the perspective front view of the invention.

FIG. 2 is the perspective rear view of the invention.

FIG. 3 is the exploded perspective view of the invention.

FIG. 4 is the block diagram for the control circuit of the invention.

FIGS. 5 and 6 are working views of the invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

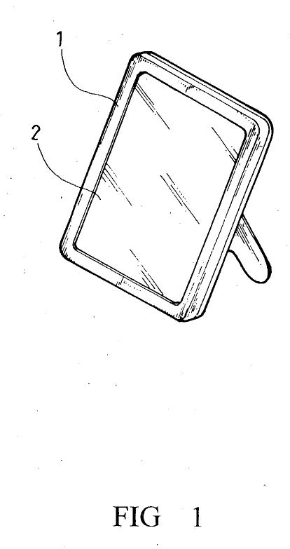

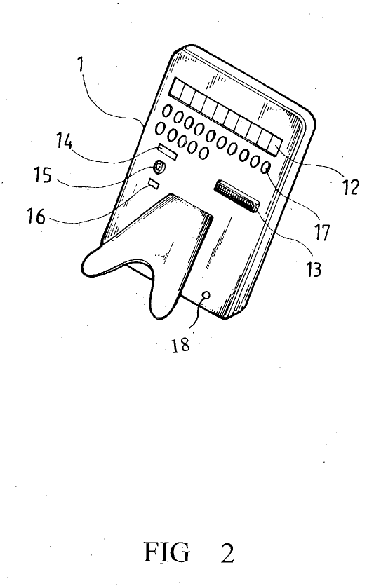

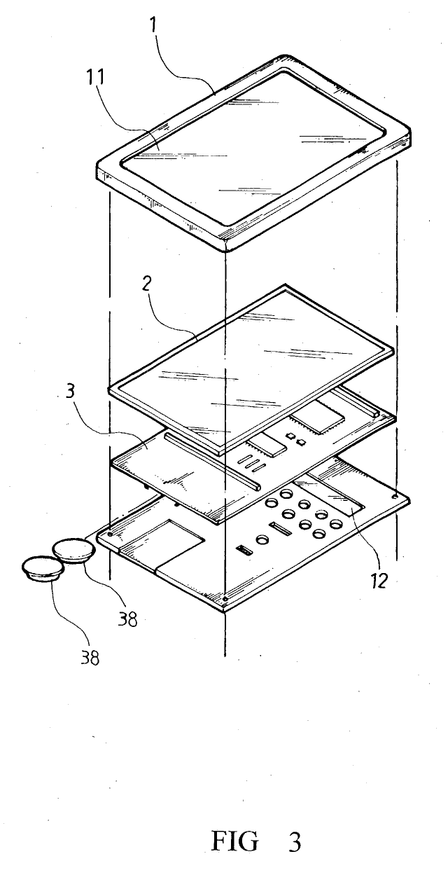

Referring to FIGS. 1, 2 and 3, the invention mainly includes a picture frame body 1, a bistable display 2 and control circuit 3. After being assembled, the bistable display 2 and the control circuit 3 are fitted in the frame body 1. The front part of the frame body 1 is provided with a window 11 for showing on the bistable display 2. Provided on the back part of the frame body 1 are a multiplicity of windows 12, a card reader port 13, an infrared receiving device 14, a USB connecting rod 15, a Bluetooth receiving device 16 and a multiplicity of push buttons 17. The working power supply 38 for the whole control circuit 3 and the bistable display 2 is a battery or an external power transformer that can be connected from an external power supply.

With the combination of aforementioned components, the memory card of the digital camera can be inserted into the card reader port 13 to show the variant images, one by one, on the window 12, by use of the control circuit 3 for users to select the image of variant sequence number by pushing the button 17. The displaying time of the image can also be set at the same time to make the control circuit 3 show the images, one by one, on the bistable display 2 according to the set sequence number and time. Since the image frame, after being shown, can stay on the bistable display 2 without being disappeared, the same effect as a picture or a painting can be maintained without continuous power supply.

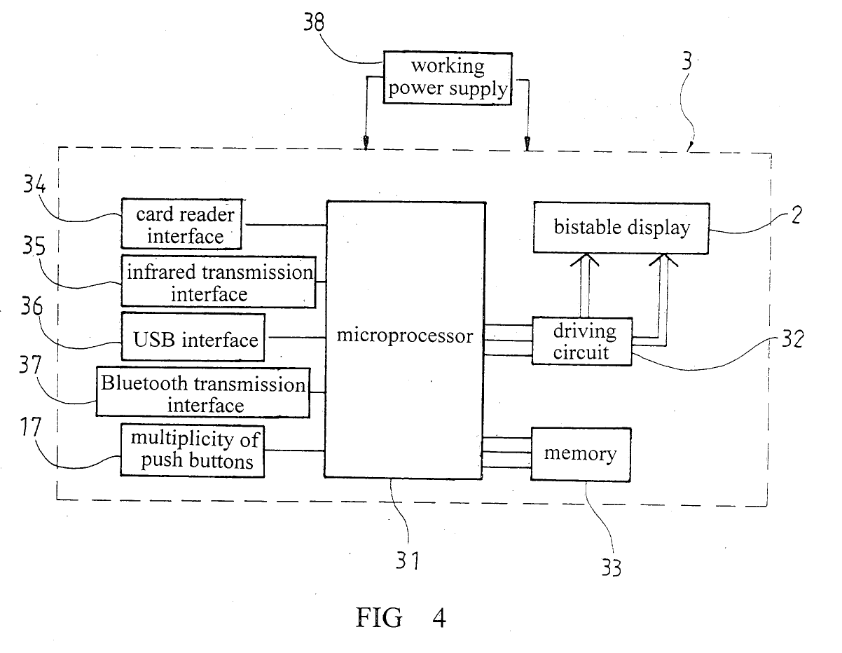

Referring to FIG. 4, the control circuit 3 of the invention includes a microprocessor 31, and a memory 33. The microprocessor is connected to a driving circuit 32, which is also connected to the bistable display 2. The memory 33 can be a nonvolatile RAM or flash memory. Furthermore, the memory 33 is provided with an image transformation program as well as an image staying and replacing program to transform the image data into image displaying format and to control the staying and the replacing time of the image by the program. What is more, the inputs of microprocessor 31 are connected to the card reader interface 34, the infrared transmission interface 35, the USB interface 36, the Bluetooth transmission interface 37 and the selection buttons 17 respectively.

In the aforementioned control circuit 3, the memory 33 is provided with an image transformation program as well as an image staying and replacing program to transform the image data into image displaying format and to control the staying and the replacing time of the image by the program. As the data in the memory card of digital camera are accessed by the card reader interface 34 and stored in the memory, the image data stored are decoded, decrypted, sorted and transformed into a displaying format through the operation of the microprocessor 31. Thereafter, variant image data are displayed on the bistable display 2 in sequence by selecting and setting via the push button 17, through the driving circuit 32 to constitute the same effect as a picture.

Moreover, the input data from variant external storage devices can be received by the infrared transmission interface 35, USB interface 36, and Bluetooth transmission interface 37, respectively by the use of the infrared receiving device 14, the USB connecting rod 15, and the Bluetooth receiving device 16. Similarly, the received image data frames are displayed on the bistable display 2 by means of the microprocessor 31, and the power supply 38 for the whole control circuit 3 is provided by a battery or a transformer connected externally.

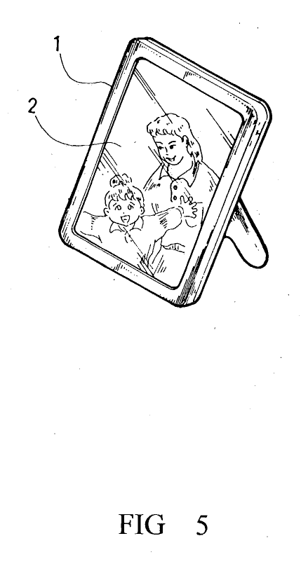

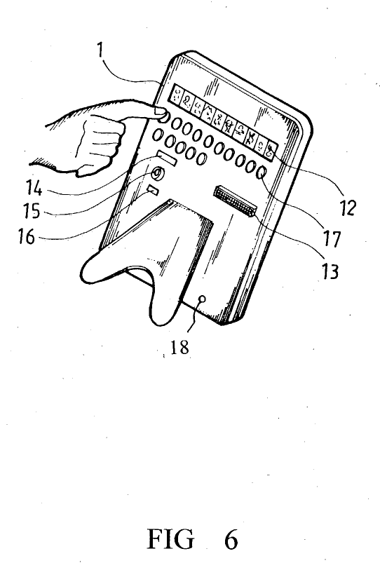

As shown in FIGS. 5 and 6, when it comes to service, the user inspects variant images from window 12 and set the sequence number and displaying time for each image frame to be displayed through push button 17. Afterward, the image frame will be displayed on the bistable display 2 provided in the front window 11 of the picture frame body 1. Since the image frame on bistable display will not be disappeared without any needs of continuous power supply during the displaying time, it can result in the same effect as a common picture. In addition, it is also able to be used as a decorating display piece or to be carried along to be a portable piece because there is no need for power to be continuously supplied.

It will be understood that each of the elements described above, or two or more together may also find a useful application in other types of methods differing from the type described above.

While certain novel features of this invention have been shown and described and are pointed out in the annexed claim, it is not intended to be limited to the details above. This is because that it will be understood that various omissions, modifications, substitutions and changes in the forms and details of the device illustrated and in its operation can be made by those skilled in the art without departing in any way from the spirit of the invention.

I claim:

1. A multi-development picture and picture-frame structure, comprising:
a picture-frame body, having a development window provided in the front and a multiplicity of inspecting window, a card reader port, and a multiplicity of selection push buttons provided on the backside therein;
a card reader, for accessing—image data in the memory card of a digital camera;
a memory, being a nonvolatile random access memory or flash memory, is used for storing the image data accessed from the card reader;
a microprocessor, connected to a multiplicity of selection buttons, the card reader, the memory and its driving circuit respectively for providing image selection signals and time setting for manipulating push buttons, as well as performing decoding, decrypting and sorting on the data stored in the memory in order to transform the data into display format;
a driving circuit, for driving the bistable display;
a bistable display, connected to the driving circuit for displaying the image data; and
a working power supply, being a battery, for providing the power source required by the whole control circuit and the bistable display;
whereby the digital image data accessed from the card reader can be shown on the bistable display by selecting the variant frame and displaying time by employing the combination of the above-mentioned devices, and by employing the bistable display, the image can be stayed to constitute the displaying effect as a photo picture without continuous power supply.

2. The multi-development picture and picture-frame structure as claimed in claim 1, wherein the memory is provided with an image transformation program as well as an image staying and replacing program in order to transform the digital image data into the image displaying format, and the staying and replacing time of the image can be controlled by the program.

3. The multi-development picture and picture-frame structure as claimed in claim 1, wherein the microprocessor is further connected to a USB interface, and/or an infrared transmission interface, and/or a Bluetooth transmission interface, to receive the input data from various external storage devices and store them in the memory.

4. The multi-development picture and picture-frame structure as claimed in claim 1, wherein the microprocessor is further connected to an infrared transmission interface, and the input data are received from various external storage devices and stored in the memory through the infrared receiving device.

5. The multi-development picture and picture-frame structure as claimed in claim 1, wherein the microprocessor is further connected to the Bluetooth transmission interface, and the input data are received from various external storage devices and stored in the memory through the Bluetooth receiving device.

6. The multi-development picture and picture-frame structure as claimed in claim 1, wherein the working power supply can be connected from the external power source transformer through the power source outlet for providing the power source required by the whole control circuit and the bistable display.
